(19) United States
(12) Patent Application Publication
(10) Pub. No.: US 2003/0115127 A1
(43) Pub. Date: Jun. 19, 2003

(54) Method of market basket bidding for surplus merchandise

(75) Inventor: Brian P. Delbarba, Pittsburgh, PA (US)

Correspondence Address: Daniel H. Golub, Morgan, Lewis & Bockius LLP, 1701 Market Street, Philadelphia, PA, 19103, US

(73) Assignee: FreeMarkets, Inc.

(21) Appl. No.: 10/022,475

(22) Filed: Dec. 18, 2001

(51) Int. Cl. G06F 17/60

(52) U.S. Cl. 705/37

(57) ABSTRACT

A method of market basket bidding for surplus merchandise, including soliciting bids for a plurality of lots, each lot having a comparison value, receiving a plurality of bids on combinations of the lots from a plurality of buyers, at least one lot receiving bids from more than one buyer being an overlap portion, and awarding the overlap portion to a winning buyer, the winning buyer having submitted a bid on a combination that includes the overlap portion, wherein the bid submitted by the winning buyer has a parameter having a higher parameter value than other parameters calculated from bids from other buyers, the parameter being a percentage over a total comparison value for the combination.

### FIELD OF THE INVENTION

The invention relates generally to conducting online electronic auctions, and in particular, to bidding on a market basket of surplus goods and/or services.

### BACKGROUND OF THE INVENTION

Procurement of goods and services has traditionally involved high transaction costs, especially information search costs. The advent of electronic commerce has introduced new methods of procurement that may lower some of the transaction costs associated with procurement. Electronic procurement, or in particular business-to-business electronic commerce, matches buyers and suppliers and facilitates transactions that take place on networked processors.

There are several models of online procurement, including catalog, buyer-bidding auctions, seller bidding auctions, and exchange marketplaces. In a buyer-bidding auction, bid prices may start low and move upward in an auction format as buyers interact to establish a closing price. The auction marketplace is often one-sided, i.e., one supplier and many potential buyers. It is believed that, typically, the products being purchased are components or materials. “Components” may mean fabricated tangible pieces or parts that become part of assemblies of durable products. Example components may include gears, bearings, appliance shelves, or door handles. “Materials” may mean bulk quantities of raw materials that are further transformed into product. Example materials include corn syrup or sheet steel.

It is believed that auctions for surplus merchandise routinely have a wide variety of low value products. Buyers may have varying needs for these products, so it may be difficult to place these products into lots that are desirable to many buyers. If the buyers could only bid on certain lots that contained some undesirable products, then those buyers may not offer a high bid or may not even participate in the auction at all. As a result, the buyers, as well as the suppliers, may not benefit from participating in the auction.

### SUMMARY OF THE INVENTION

The invention provides a method of market basket bidding for surplus merchandise. This method includes soliciting bids for a plurality of lots, receiving a plurality of bids on combinations of the lots from a plurality of buyers, and awarding overlap portions to a winning buyer, who submitted a bid on a combination that includes the overlap portion and has a parameter with a higher parameter value than other parameters calculated from bids from other buyers. At least one lot receiving bids from more than one supplier is an overlap portion, each lot has a comparison value, and the parameter is a percentage over a total comparison value for the combination.

The invention provides another method of market basket bidding for surplus merchandise. This method includes soliciting bids for a plurality of lots, receiving a plurality of bids on combinations of the lots from a plurality of buyers, notifying the buyers bidding on an overlap portion, allowing buyers to raise bids on the overlap portion, at least one lot in the overlap portion, or the combination, awarding the overlap portion of the lots to a winning buyer, who submitted a bid on a combination that includes the overlap portion and has a parameter with a higher parameter value than other parameters calculated from bids from other buyers, allotting the lots in the combination not included in the overlap portion to the buyers bidding on the lots, and requiring the buyers to purchase all of the lots allotted and awarded. At least one lot receiving bids from more than one buyer is an overlap portion, each lot has a comparison value, and the parameter is a percentage over a total comparison value for the combination.

The invention also provides a system of market basket bidding for surplus merchandise. This system includes a database for receiving and storing a plurality of bids for combinations of lots selected by a plurality of buyers and comparison values for the lots, and software for awarding the overlap portion to a winning buyer, who submitted a bid on a combination that includes the overlap portion and has a parameter with a higher parameter value than other parameters calculated from bids from other buyers. At least one lot receiving bids from more than one buyer is the overlap portion, and the parameter is a percentage over a total comparison value for the combination.

The invention further provides a machine readable medium for implementing a market basket bidding for surplus merchandise. This machine readable medium includes a first machine readable code that receives a plurality of bids for combinations of lots selected by a plurality of buyers, a second machine readable code that stores comparison values and minimum purchase prices for the lots, and a third machine readable code that awards an overlap portion to a winning buyer, who submitted a bid on a combination that includes the overlap portion and has a parameter with a higher parameter value than other parameters calculated from bids from other buyers. At least one lot receiving bids from more than one buyer is the overlap portion, and the parameter is a percentage over a total comparison value for the combination.

### BRIEF DESCRIPTION OF THE DRAWINGS

The accompanying drawings, which are incorporated herein and constitute a part of this specification, illustrate the presently preferred embodiments of the invention and, together with the general description given above and the detailed description given below, serve to explain the features of the invention.

In the drawings:

FIG. 1A is a flow diagram of a request for quotation in an auction;

FIG. 1B is a flow diagram of a bidding process in an auction;

FIG. 1C is a flow diagram of a contract award following an auction;

FIG. 2 is a schematic illustration of communications links between the coordinator, the supplier, and the buyers in an auction;

FIG. 3 is a block flow diagram of an embodiment of the method of the invention; and

FIG. 4 is a schematic illustration of auction software and computers hosting that software in an auction.

### DETAILED DESCRIPTION OF THE PREFERRED EMBODIMENTS

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical auction systems and computer networks.

The invention provides a method of market basket bidding for surplus merchandise. The invention is designed to create a market of competition in business transactions. The method is particularly applicable to online auctions where buyers, or bidders, submit bids to an auction coordinator electronically during the auction process. The method provides buyers with an option to bid on a selection of only those products that they desire. The option may provide a greater incentive to buyers to offer a greater fraction of the retail price and improved results for asset exchange.

The following description of the features of the present invention is presented in the context of upward-based online industrial auctions. However, as would be appreciated by one of ordinary skill in the relevant art, these inventive features could also be applied in the context of downward-based online auctions as well.

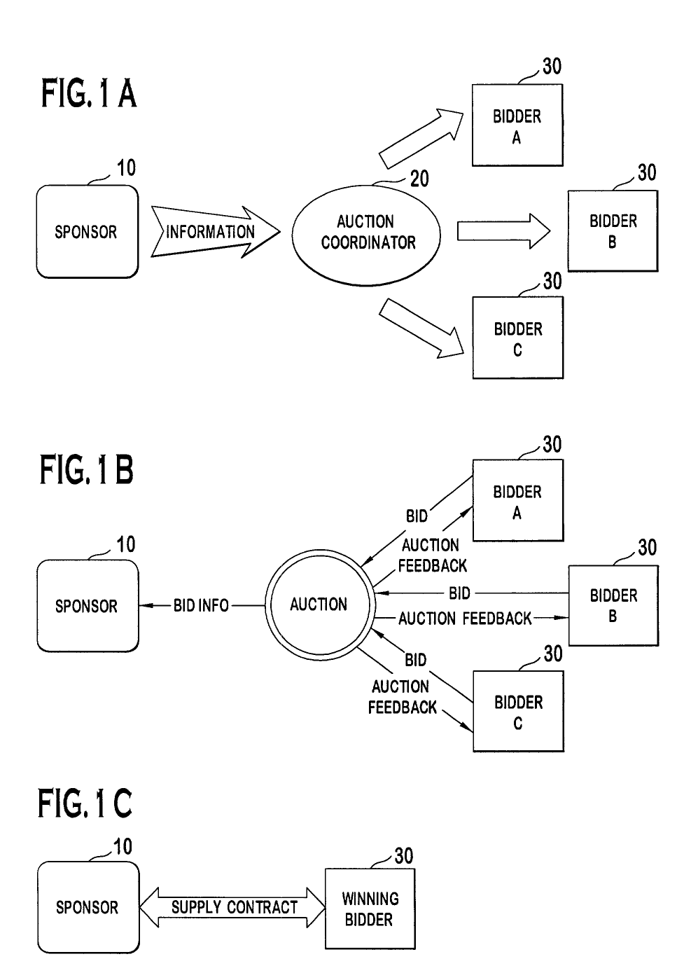

The basic process for a seller sponsored buyer-bidding auction is described below with reference to FIG. 1. FIG. 1 illustrates the functional elements and entities involved in setting up and conducting a typical buyer-bidding auction. FIG. 1A illustrates the creation of an auctioning event, FIG. 1B illustrates the bidding during an auction, and FIG. 1C illustrates results after completion of a successful auction.

In the auction model, the products or services to be sold are, preferably, defined by the sponsor, or originator, 10 of the auction, as shown in FIG. 1A. Alternatively, the seller may set up all or some of its own bidding events and find its own buyers. In that case, the sponsor 10 would run the events through a market operations center, which is a facility where auctions are monitored and participants receive assistance. If the sponsor 10 decides to use the auctioning system of the present invention to sell products or services, the sponsor 10 may provide information to an auction coordinator 20. That information may include information about incumbent buyers and historic prices paid for the products or services to be auctioned, for example. Preferably, the sponsor 10 also works with the auction coordinator 20 to define the products and services to be sold in the auction and lot the products and services appropriately so that desired products and services can be sold. A specification may then be prepared for each product or service.

Next, the auction coordinator 20 may identify potential bidders, or buyers 30, preferably with input from the sponsor 10, and invite the potential buyers 30 to participate in the upcoming auction. The buyers 30 that are selected to participate in the auction may become bidders 30.

As shown in FIG. 1B, during a typical auction, bids are made for lots. During the auction, the sponsor 10 may typically monitor the bidding as it occurs. Bidders 30 may also be given market feedback during the auction so that they may bid competitively. After the auction, the auction coordinator 20 may analyze the auction results with the sponsor 10. The sponsor 10 may conduct final qualification of the high bidding buyer or buyers 30. The sponsor 10 may furthermore retain the right not to sell products and/or services to a high bidding buyer 30 based on final qualification or other business concerns. As shown in FIG. 1C, a supply contract may be drawn up for the winning bidder 30 and executed based on the results of the auction. The supply contract may have the products and/or services to be provided to the winning bidder 30.

The auction may be conducted electronically between bidders 30 at their respective remote sites and the auction coordinator 20 at its site. Alternatively, instead of the auction coordinator 20 managing the auction at its site, the sponsor 10 may perform auction coordinator tasks at its site.

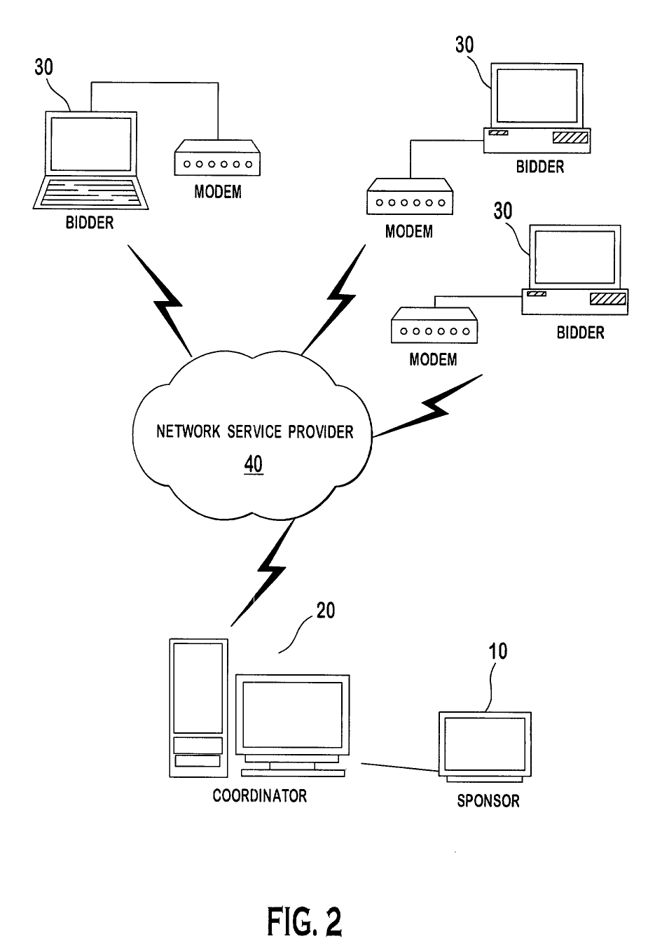

Information may be conveyed between the coordinator 20 and the bidders 30 via any communications medium. As shown in FIG. 2, bidders 30 may be connected to the auction through the Internet via a network service provider 40 accessed, for example, through a dial-up telephone connection. Alternatively, sponsors 10 and bidders 30 may be coupled to the auction by communicating directly with the auction coordinator 20 through a public switched telephone network, a wireless network, or any other connection.

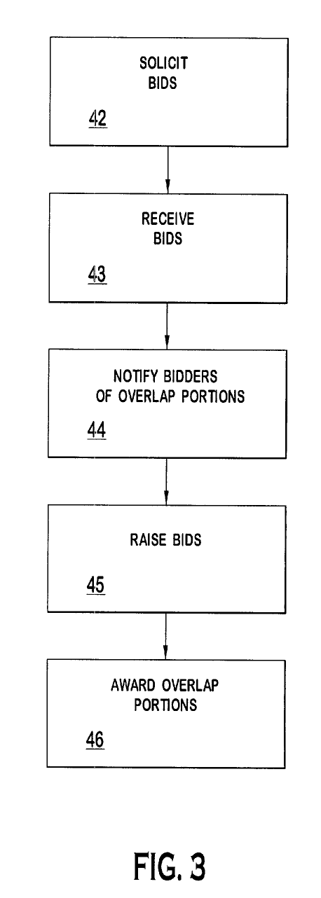

In the preferred embodiment, bids are solicited by the auction coordinator 20 for a plurality of lots in step 42, as shown in FIG. 3. Each lot has a comparison value and, preferably, a minimum purchase price. In the preferred embodiment, the list price is used as a basis for comparison among line items, which is particularly applicable to a manufacturer or retailer as a sponsor 10. However, other comparison values may be used, such as purchase price, a depreciated cost, or other methods of comparison. For example, if a manufacturer discontinues a product line, has a surplus raw materials (wire, for example), and wishes to auction off the surplus wire to electrical distributors, the manufacturer may be concerned with the amount of writedown that will have to be taken when the product is auctioned. In this case, the manufacturer's purchase price or depreciated cost would be an appropriate basis for comparison. If displaying to the buyers 30, the manufacturer's cost may be modified, or disguised, by multiplying the actual cost by a factor known only to the seller, or sponsor 10. What is most important is that the comparison value relationship among the various line items accurately reflects the seller's willingness to sell the line items.

In the preferred embodiment, the auction coordinator 20 identifies the goods and/or services to be purchased. Bids are received from bidders 30 for combinations of lots in step 43. The combination of lots is selected, and a price if offered for the combination. These combinations may also be referred to as market baskets, where the buyer 30 places items in his market basket and submits a bid on the entire market basket. Buyers 30 may be limited to the number of market baskets on which they may bid. The market baskets may also be fixed before bidding, where only a limited number of items may be placed in the market basket, certain items must be placed in the market basket, the bid on the items in the market basket must reach a specific dollar amount, or any other limitation. Bidders 30 may compete with each other on different lots in the combination. Any lots that receive bids from more than one buyer 30 are overlap portions. For example, as shown in Table 1 below, if buyer 1 bids on lots, or Items, A, B, and C and buyer 2 bids on Items C, D, and E, lot C would be the overlap portion.

TABLE 1

| Item | List Price | Buyer 1 | Buyer 2 |
|---|---|---|---|
| A | 3 | $5.00 | |
| B | 3 | | |
| C | 4 | | |
| D | 5 | | $10.00 |
| E | 6 | | |

In step 44, bidders 30 are, preferably, notified of any overlap portions on which they have bid. This allows bidders 30 to increase their bids in order to win the overlap portions, which contain desired lots. In step 45, in order to win the overlap portion, the bidders 30 may raise the bid on the overlap portion only, the bid on one or more lots in the overlap portion, or preferably, the bid on the combination.

In step 46, the overlap portions are awarded to winning buyers 30, who submitted bids on their combinations that have a parameter with a higher parameter value than other parameters calculated from bids from other buyers 30. The higher value parameter is the highest percentage over a total comparison value for the combination. The parameter, or effective multiplier, for each buyer 30 is calculated by adding the comparison values of the lots in the combination and dividing the bid on the combination by the total comparison value for the lots. For example, using the information in Table 1 above, for buyer 1, the total list price is $10 ($3+$3+$4), and the parameter is 1/2 or 50% ($5/$10). For buyer 2, the total list price is $15 ($4+$5+$6), and the parameter is 2/3 or 66% ($10/$15). Since buyer 2's offer represents 66% of the total list price versus 50% of total list price for buyer 1, buyer 2 would be awarded Item C, the overlap portion, as will as Items D and E, the other lots in buyer 2's combination.

Preferably, buyer 1 would then be required to purchase Items A and B. These items would be awarded, or allotted, to buyer 1 because he was the only bidder on the items. Buyer 1 would have to pay 50% of the total list price for Items A and B, which amounts to $3.00.

In the preferred embodiment, minimum purchase prices would be in place and would be communicated to the buyers 30 in advance of the auction. Offers below the minimum would be refused on a dollar volume basis. A bid of $2 on Item A, for example, would be refused because the bid was below the minimum of $3, which, in this case, is the list price.

In addition, the parameters may be adjusted based on bidding on certain items, bidding on a large volume of lots, or biding on a large dollar volume. Bidding on certain items may entail a discount on one lot if the buyer 30 bids on another lot, a discount on particular groupings of lots, or any other possible arrangement. A seller may also want to provide an advantage to a buyer 30 who includes hard-to-sell merchandise in their market basket. The parameter may be adjusted according to the bidding. For example, if buyer 1 increases the $5 offer to $14 for Items A-E and it was determined before the auction that any offers over $12 (dollar volume basis) or offers for all lots (volume of lots basis) would receive an advantage, the parameter would be offered a certain percentage of advantage for comparison purposes.

A computer software application may be used to manage the auction. Preferably, as shown in FIG. 3, the software application has two components: a client component 16 and a server component 23. The client component 16 may operate on a computer at the site of each of the potential buyers 30. Buyers 30 make bids during the auction using the client component 16. The bids may be sent via the network service provider 40 to the site of the coordinator, where it is received by the server component 23 of the software application. The client component 16 may include software used to make a connection through telephone lines or the Internet to the server component 23. Bids may be submitted over this connection and updates may be sent to the connected buyers 30.

Bids may only be submitted using the client component 16 of the application. This ensures that buyers 30 do not circumvent the bidding process, and that only invited buyers participate in the bidding. Bidders 30 may see their bids and bids placed by other buyers for each lot on the client component 16. Preferably, when a buyer 30 submits a bid, that bid is sent to the server component 23 and evaluated to determine whether the bid is from an authorized bidder and whether the bid has exceeded a pre-determined minimum acceptable price. Bids placed by a buyer 30 may be broadcast to all connected buyers 30, thereby enabling every participating buyer 30 to quickly view the change in market conditions and begin planning their competitive responses.

The embodiments of the invention may be implemented by a processor-based computer system. The system includes a database for receiving and storing bids for combinations of lots selected by buyers 30 and comparison values for the lots, and software for awarding an overlap portion to a winning buyer 30, who submitted a bid on a combination that includes the overlap portion and has a parameter with a higher value than other parameters calculated from bids from other buyers 30. The lots receiving bids from more than one buyer 30 are the overlap portions, and the parameter is a percentage over a total comparison value for the combination.

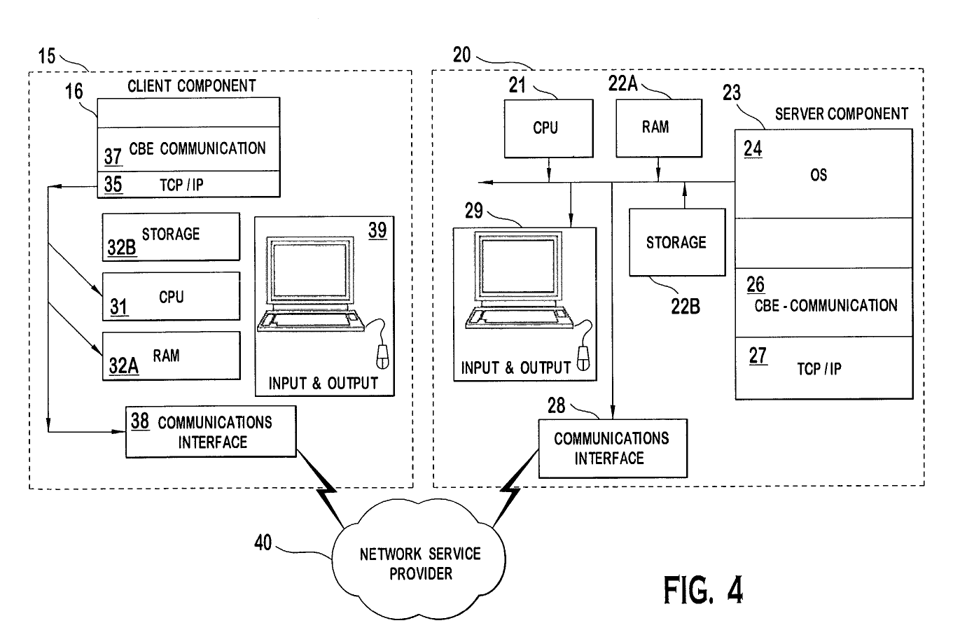

With reference to FIG. 4, a computer system 20 operates to execute the functionality for server component 23. Computer system 20 includes a processor 21, a memory 22A and a disk storage 22B. Memory 22A stores computer program instructions and data. Processor 21 executes the program instructions or software, and processes the data, stored in memory 22A. Disk storage 22B stores data to be transferred to and from memory 22A. All these elements are interconnected by one or more buses, which allows data to be intercommunicated between the elements.

Processor 21 may be any type of processor capable of providing the speed and functionality required by the embodiments of the invention. For example, processor 21 could be a processor from a family of processors made by Intel Corporation or Motorola.

For purposes of this application, memory 22A and disk 22B are machine readable mediums and could include any medium capable of storing instructions adapted to be executed by a processor. Some examples of such media include, but are not limited to, read-only memory (ROM), random-access memory (RAM), programmable ROM, erasable programmable ROM, electronically erasable programmable ROM, dynamic RAM, magnetic disk (e.g., floppy disk and hard drive), optical disk (e.g., CD-ROM), optical fiber, electrical signals, lightwave signals, radio-frequency (RF) signals and any other device or signal that can store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor. Further, system 20 may contain various combinations of machine readable storage devices, which are accessible by processor 21 and which are capable of storing a combination of computer program instructions and data.

Memory 22A is accessible by processor 21 over a bus and includes an operating system, a program partition and a data partition. The program partition stores and allows execution by processor 21 of program instructions that implement the functions of each respective system described herein. The data partition is accessible by processor 21 and stores data used during the execution of program instructions. For some embodiments of the invention, the program partition contains program instructions that performs the buy versus leasing transformation functionality described above.

Computer system 20 also includes a network interface 28. Network interface 28 may be any suitable means for controlling communication signals between network devices using a desired set of communications protocols, services and operating procedures. Communication protocols are layered, which is also referred to as a protocol stack, as represented by operating system 24, a CBE-communication layer 26, and a Transport Control Protocol/Internet Protocol (TCP/IP) layer 27. Network interface 28 also includes connectors for connecting interface 28 with a suitable communications medium. Those skilled in the art will understand that network interface 28 may receive communication signals over any suitable medium such as twisted-pair wire, co-axial cable, fiber optics, radio-frequencies, and so forth.

FIG. 4 also shows a computer system 15 that operates to execute the functionality for client component 16. Computer system 15 includes a processor 31, a memory 32A, disk storage 32B, a communications interface 38, and a protocol stack having a CBE-communication layer 37 and a TCP/IP layer 35. These elements operate in a manner similar to the corresponding elements for computer system 20.

Another embodiment of the invention includes a first machine readable code that receives bids for combinations of lots selected by buyers 30, a second machine readable code that stores comparison values and minimum purchase prices for the lots, and a third machine readable code that awards an overlap portion to a winning buyer 30, who submitted a bid on a combination that includes the overlap portion and has a parameter with a higher parameter value than other parameters calculated from bids from other buyers 30. The lots receiving bids from more than one buyer 30 are the overlap portions, and the parameter is a percentage over a total comparison value for the combination.

While the invention has been described in detail and with reference to specific embodiments thereof, it will be apparent to one skilled in the art that various changes and modifications can be made therein without departing from the spirit and scope thereof. Thus, it is intended that the present invention covers the modifications and variations of this invention provided they come within the scope of the appended claims and their equivalents.

What is claimed is:

1. A method of market basket bidding for surplus merchandise comprising:
soliciting bids for a plurality of lots, each lot having a comparison value;
receiving a plurality of bids on combinations of the lots from a plurality of buyers, at least one lot receiving bids from more than one buyer being an overlap portion; and
awarding the overlap portion to a winning buyer, the winning buyer having submitted a bid on a combination that includes the overlap portion,
wherein the bid submitted by the winning buyer has a parameter having a higher parameter value than other parameters calculated from bids from other buyers, the parameter being a percentage over a total comparison value for the combination.

2. The method of claim 1 wherein the soliciting comprises:
identifying at least one of goods and services to be purchased.

3. The method of claim 1 wherein the soliciting comprises:
providing a list price and a minimum purchase price for each lot to the buyer.

4. The method of claim 1 wherein the receiving comprises:
selecting, by the buyer, the combination of lots desired; and
offering a price for the combination of lots.

5. The method of claim 1 wherein the awarding comprises:
dividing the bid on the combination by the total comparison value;
determining effective multipliers; and
comparing the effective multipliers of buyers competing for the overlap portions.

6. The method of claim 1 wherein the awarding comprises:
allotting the lots in the combination not included in the overlap portion to the buyer bidding on the lots.

7. The method of claim 6 further comprising:
requiring the buyers to purchase all of the lots awarded.

8. The method of claim 1 further comprising:
notifying buyers bidding on the overlap portion;
allowing the buyers to raise the bid on at least one of the overlap portion, at least one lot in the overlap portion, and the combination.

9. The method of claim 1 wherein the awarding comprises:
adjusting the parameter for combinations having at least one of a larger volume of lots, a larger dollar volume, and specified lots.

10. The method of claim 1 further comprising:
offering a discount on one lot if the buyer bids on another lot.

11. The method of claim 1 wherein the soliciting comprises:
multiplying the comparison value by a factor to calculate a modified cost; and
providing the modified cost to the buyers.

12. A method of market basket bidding for surplus merchandise comprising:
soliciting bids for a plurality of lots, each lot having a comparison value and a minimum purchase price;
receiving a plurality of bids on combinations of the lots from a plurality of buyers, at least one lot receiving bids from more than one buyer being for overlap portion;
notifying the buyers bidding on the overlap portion;
allowing the buyers to raise bids on at least one of the overlap portion, at least one lot in the overlap portion, and the combination;
awarding the overlap portion to a winning buyer, the winning buyer having submitted a bid on a combination that includes the overlap portion, wherein the bid submitted by the winning buyer has a parameter having a higher parameter value than other parameters calculated from bids from other buyers, the parameter being a percentage over a total comparison value for the combination;
allotting the lots in the combinations not included in the overlap portion to the buyers bidding on the lots; and
requiring the buyers to purchase all of the lots allotted and awarded.

13. A system for market basket bidding for surplus merchandise comprising:
a database for receiving and storing a plurality of bids for combinations of lots selected by a plurality of buyers and comparison values for the lots, at least one lot receiving bids from more than one buyer being an overlap portion; and
software for awarding the overlap portion to a winning buyer having submitted a bid on a combination that includes the overlap portion, the bid submitted by the winning buyer having a parameter with a higher parameter value than other parameters calculated from bids from other buyers, the parameter being a percentage over a total comparison value for the combination.

14. The system of claim 13 wherein the parameter comprises an adjustment for at least one of a larger volume of lots, a larger dollar volume, and specified lots.

15. The system of claim 13 wherein the lots comprise at least one of goods and services.

16. The system of claim 13 wherein the software divides each bid by the total comparison value, determines effective multipliers, and compares the effective multipliers of the buyers competing for the overlap portions.

17. The system of claim 13 wherein the database comprises a minimum purchase price for each lot.

18. The system of claim 13 wherein the software allots the lots in the combination not included in the overlap portion to the buyer bidding on the lots.

19. The system of claim 18 wherein the buyer purchases the lots awarded and allotted.

20. The system of claim 13 wherein the comparison value comprises at least one of a list price, a purchase price, and a depreciated cost.

21. The system of claim 13 wherein the comparison value comprises a cost multiplied by a factor.

22. A machine readable medium for market basket bidding for surplus merchandise comprising:
a first machine readable code that receives a plurality of bids for combinations of lots selected by a plurality of buyers, at least one lot receiving bids from more than one buyer being an overlap portion;
a second machine readable code that stores comparison values and minimum purchase prices for the lots; and
a third machine readable code that awards the overlap portion to a winning buyer, having submitted a bid on a combination that includes the overlap portion, the bid submitted by the winning buyer having a parameter with a higher parameter value than other parameters calculated from bids from other buyers, the parameter being a percentage over a total comparison value for the combination.

23. The machine readable medium of claim 22 wherein the parameter comprises an adjustment for at least one of a larger volume of lots, a larger dollar volume, and specified lots.

24. The machine readable medium of claim 22 wherein the third machine readable code divides each bid by the total list price, determines effective multipliers, and compares the effective multipliers of the buyers competing for the overlap portions.

25. The machine readable medium of claim 22 wherein the third machine readable code allots the lots in the combination not included in the overlap portion to the buyer bidding on the lots.

26. The machine readable medium of claim 25 wherein the buyer purchases the lots awarded and allotted.

27. The machine readable medium of claim 22 wherein the comparison value comprises at least one of a list price, a purchase price, and a depreciated cost.

28. The machine readable medium of claim 22 the comparison value comprises a cost multiplied by a factor.
